(19) United States
(12) Patent Application Publication
(10) Pub. No.: US 2008/0127453 A1
(43) Pub. Date: Jun. 5, 2008

(54) Auto-door device

(76) Inventors: Wen-Lin Zhang, Zhejiang (CN); Yi-Feng You, Zhejiang (CN); Jun-Huai Xu, Zhejiang (CN); Ren-Luo Cai, Zhejiang (CN)

Correspondence Address: CHARLES E. BAXLEY, ESQ., 90 JOHN STREET, THIRD FLOOR, NEW YORK, NY, 10038, US

(21) Appl. No.: 11/073,194

(22) Filed: Mar. 4, 2005

(51) Int. Cl. E05F 1/08

(52) U.S. Cl. 16/72

(57) ABSTRACT

The present invention relates to an auto-door device and particularly to an auto-door device used for a hinged door panel, and the auto-door device includes an axle pivotally coupled to a door panel and an axle resilient hinge; characterized in that the axle is coupled to the one-way transmission mechanism at the same time, and the output end of the one-way transmission mechanism is linked to the magnetic damper mechanism. By changing a regular resilient damper mechanism to the magnetic damper mechanism, the auto-door device in accordance with the present invention can control the door shutting speed for an even, constant and stable movement and adjust the speed of opening a door arbitrarily without being affected by the external factors such as different seasons and temperature. The present invention has the advantages of being leakage free, pollution free, safe, and reliable as well as a long life of use.

### BACKGROUND OF THE INVENTION

1. Field of the Invention

The present invention relates to an auto-door device, and more particularly to an auto-door device used for a hinged door panel as well as a sliding door panel.

2. Description of the Related Art

A door device generally includes a door shutter, a floor hinge, an axle pivotally coupled to a door panel, and an axle resilient hinge; and the door device further includes a resilient damper mechanism if slow door resumption is required. In general, the resilient damper mechanism is installed in a housing and divided into a hydraulic type and a pneumatic type. Most of the door shutters and floor hinges sold in the market are of the hydraulic type, and the door shutting speed is controlled by an oil damper. However, the oil viscosity will change with a temperature change during its use and thus different door shutting speeds will result in different seasons. As the viscosity of oil increases, the speeds of the door shutter and the floor hinge become slower which will affect the door shutting and heat preserving effects. In addition, the door shutter of an oil damper leaks and permeates oil easily and thus causes an environmental pollution.

### SUMMARY OF THE INVENTION

To overcome the shortcomings of the door shutting speed of a prior-art hydraulic door shutter being affected by the external temperature easily, and solve the oil leak and permeation problems, the present invention provides an auto-door device having a reliable steady door closing speed and a safe pollution-free feature.

A further objective of the present invention is to provide an auto-door device that can adjust its door shutting speed and provides a reasonable mechanical engagement easily.

To achieve the foregoing objectives, the auto-door device of the present invention comprises an axle pivotally coupled to a door panel and an axle resilient hinge; characterized in that the axle is linked to a one-way transmission mechanism at the same time, and the output end of the one-way transmission mechanism is linked to a magnetic damper.

The present invention changes a regular resilient damper mechanism and adopts a magnetic damper mechanism to shut a door evenly, steadily and stably and the door opening speed can be controlled arbitrarily without being affected by external factors such as different seasons and different temperatures. The present invention has the advantages of leakage free, pollution free, safe, reliable, and a long life of use.

The magnetic damper mechanism is preferably a mechanism derived from the principle of passing the magnetic lines of force through the magnetic damper mechanism to produce the damping force. The most popular and general magnetic line cutting type dampers are similar to the magnetic line cutting type device used in electric engineering (particularly for direct current electric engineering). Of course, the present invention also includes a magnetic damper mechanism specially designed to be installed in a specific space or position, which utilizes the attraction and repulsion principles of magnetism. In the magnetic damper mechanism that adopts the magnetic lines of force in accordance with the present invention, the output end of the one-way magnetic damper mechanism is coupled to a rotor in a change drive mechanism and a magnetic line cutting type magnetic damper mechanism.

The present invention further installs a variable resistor serially connected to a circuit of a coil which is passed through with magnetic lines of force in the corresponding magnetic damper mechanism. The variable resistor is also known as a potentiometer for adjusting the rotary speed of the auto-door device according to the resistance of the potentiometer. The larger the resistance of the potentiometer, the smaller is the current passing through the coil in the magnetic line cutting type device; the smaller is the magnetic damping force; and the faster is the outputted rotary speed of the door shutter. On the other hand, the smaller the resistance of the potentiometer, the slower is the outputted rotary speed for implementing a stepless speed regulation.

While the invention has been described by a preferred embodiment with the accompanying drawings, but it is to be understood that the invention is not limited thereto.

### BRIEF DESCRIPTION OF THE DRAWINGS

FIG. 1 is a schematic view of the structure of a door shutter according to a preferred embodiment of the present invention;

FIG. 2 is a cross-sectional view of the section A-A as depicted in FIG. 1;

FIG. 3 is a schematic view of a door shutter being connected externally according to the present invention;

FIG. 4 is a schematic view of the structure of a floor hinge according to a preferred embodiment of the present invention;

FIG. 5 is a cross-sectional view of the section B-B as depicted in FIG. 4; and

FIG. 6 is a schematic view of the structure of a magnetic line cutting type magnetic damper according to the present invention.

### DETAILED DESCRIPTION OF THE PREFERRED EMBODIMENTS

To make it easier for our examiner to understand the objective of the invention, its structure, innovative features, and performance, we use a preferred embodiment together with the attached drawings for the detailed description of the invention.

With reference to the figures, the present invention provides two types of auto-door devices as described in the preferred embodiments, and they are the door shutters and the floor hinges. Both the door shutter and floor hinge have an axle 1 coupled to a door panel, a corresponding axle resilient hinge being coupled to a one-way transmission mechanism at the same time, and an output end of the one-way transmission mechanism is coupled with a rotor 72 through a change drive mechanism and a magnetic line cutting type magnetic damper mechanism 7.

The axle 1 of the door shutter and the door panel are coupled by means of a link rod mechanism, or directly through the pivotal connection of the door panel. The corresponding axle resilient hinge could be a torque spring or an energy storing spring 2, wherein the energy storing spring 2 is preferably an energy storing compressed spring. Therefore, it requires a sliding base with the compressed spring to be linked with the axle. For example, a rack 3 as shown in the door shutter according to the preferred embodiment is used as the sliding base with a compressed spring. The one-way transmission mechanism linked with the axle 1 could be a regular ratcheted one-way transmission mechanism or a one-way transmission mechanism having a one-way clutch mechanism. The one-way transmission mechanism adopted in the embodiment comprises a one-way wheel 5 linked to the axle 1 and a gear axle sleeve 4 disposed on the external periphery of the one-way wheel 5 corresponding to the one-way transmission. The gear axle sleeve 4 and its linked gear 41 are engaged with an input end of a gear change drive mechanism 6 to directly drive the rotor 72 in the magnetic line cutting type magnetic damper mechanism 7.

The one-way transmission mechanism adopted in this preferred embodiment is one of the more reasonable one-way frictional transmission mechanisms in the foregoing structure. In other words, the one-way wheel 5 has an aslant groove disposed on the external periphery of the one-way wheel 5 for accommodating a rolling cylinder 51 and its lateral pushing spring 52. The diameter of the rolling cylinder 51 is larger than the sum of the depth of the aslant groove at one end and the gap between the one-way wheel 5 and the gear axle sleeve 4 and smaller than the sum of the depth of the aslant groove at another end and the gap between the one-way wheel 5 and the gear axle sleeve 4. By that time, if the one-way wheel 5 linked to the axle 1 rotates in a direction, it will not drive the gear axle sleeve 4 to rotate, but it can drive the gear axle sleeve 4 to rotate in an opposite direction by the rolling cylinder 51 (which also could be a ball bearing). An aslant groove is disposed in equidistant intervals of the external periphery of the one-way wheel 5 for accommodating the rolling cylinder 51 and the lateral pushing spring, and the aslant groove is preferably an aslant curved groove to provide a better frictional transmission effect. Of course, the one-way wheel 5 and the gear axle sleeve 4 disposed on the external periphery of the one-way wheel 5 could adopt a one-way clutch mechanism to go with the one-way transmission.

In a preferred embodiment of the present invention, a variable resistor is serially connected to the circuit of a coil 76 with magnetic lines of forces passing through it in the corresponding magnetic damper mechanism. The magnetic line cutting type magnetic damper mechanism 7 includes a housing with a front panel 73 and a rear panel 74, and a stator disposed in the housing. The resistance of a variable resistor also known as a potentiometer is regulated to adjust the rotary speed of the auto-door device. The axle 1 is coupled with a rack 3, and the rack, a one-way transmission mechanism, a change drive mechanism, a magnetic damper mechanism are installed in an auto-door device housing 9, and the axle resilient hinge is installed on a sliding track of the rack 3. The regulating end 71 of the variable resistor is installed at the corresponding exposed hole of the auto-door device housing 9 to facilitate the regulation. The axle 1 and the rack 3 are linked by a direct engagement as shown in the preferred embodiment of the auto-door device or linked to a poking mechanism such as a poke rod 8 as shown in the floor hinge of the preferred embodiment. The axle 1 and the one-way transmission mechanism are linked by the rack 3 or a cam paw, and the link could be a direct connection of a spline. Further, the application of the axle in the occasion of a horizontal shifting movement has become a transmission shaft.

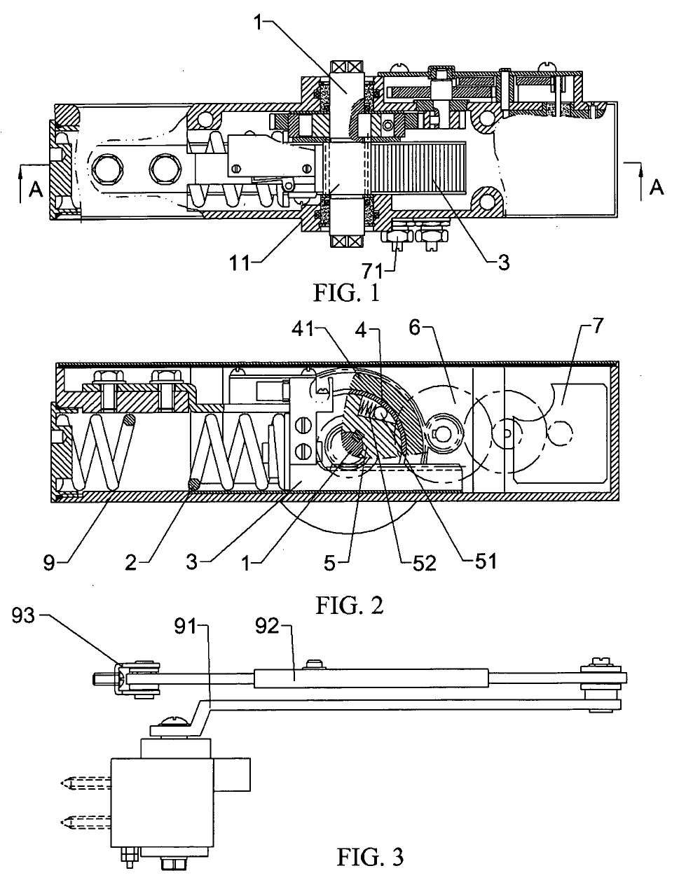

In view of the description above, the auto-door device according to the preferred embodiment of the present invention comprises a door shutter and a floor hinge. In the assembly of the auto-door device, the axle gear 11 disposed on the axle 1 in the auto-door device housing 9 is engaged directly with the rack 3, and the energy storing spring 2 is installed on a lateral side inside the auto-door device housing 9. The one-way transmission mechanism linked (which is coupled by using a key) to the corresponding axle 1, the gear change drive mechanism 6 and the magnetic line cutting type magnetic damper mechanism 7 are installed on the other side of the auto-door device housing 9. In FIGS. 1 to 3, a link rod mechanism coupled to the axle 1 includes an upper link rod 91 and a lower link rod 92 mutually hinged at one end, and the upper link rod 91 is hinged with the base which is coupled to a doorframe, and the other end of the lower link rod 92 is coupled to the axle 1. When the door is opened, the door panel is pulled or pushed, the doorframe remains fixed, so that the axle gear 11 on the axle 1 inside the auto-door device housing 9 installed on the door panel is rotated to drive the rack to shift horizontally and compress the energy storing spring 2 to store its resilient energy. In the meanwhile, the axle 1 will not transmit any force to the change drive mechanism due to the one-way action of the one-way transmission mechanism, and the magnetic damper mechanism 7 will not operate and provide no damping force, so that the door panel can be opened at the manual pulling or pushing speed. If the door panel is released, the energy storing spring 2 releases its energy, so that the rack 3 drives the axle gear 11 to rotate in an opposite direction. With the installation of a key, the one-way wheel 5 of the one-way transmission mechanism is driven; under the action of the force of the lateral pushing spring 52, the one-way wheel 5 further latches the rolling cylinder 51 to transmit forces to a gear axle sleeve 4. Since a gear 41 on the gear axle sleeve 4 is engaged with the input end of the gear change drive mechanism 6, other gears in the gear change drive mechanism 6 are driven at the same time for an accelerated rotation. The rotor 72 in the magnetic line cutting type magnetic damper mechanism 7 is rotated accordingly. The magnetic damper mechanism is operating, and the circuit of the coil 76 which is passed through by the magnetic lines of force is serially connected to a variable resistor, so that the regulation of the current produced can be achieved by the regulating end 71 of the variable resistor. Since the magnitude of the current will affect the magnitude of the magnetic damping force, therefore the smaller is the resistance of the potentiometer, the larger is the current passing through the coil, the larger is the damping force, and the slower is the door shutting speed; and vice versa.

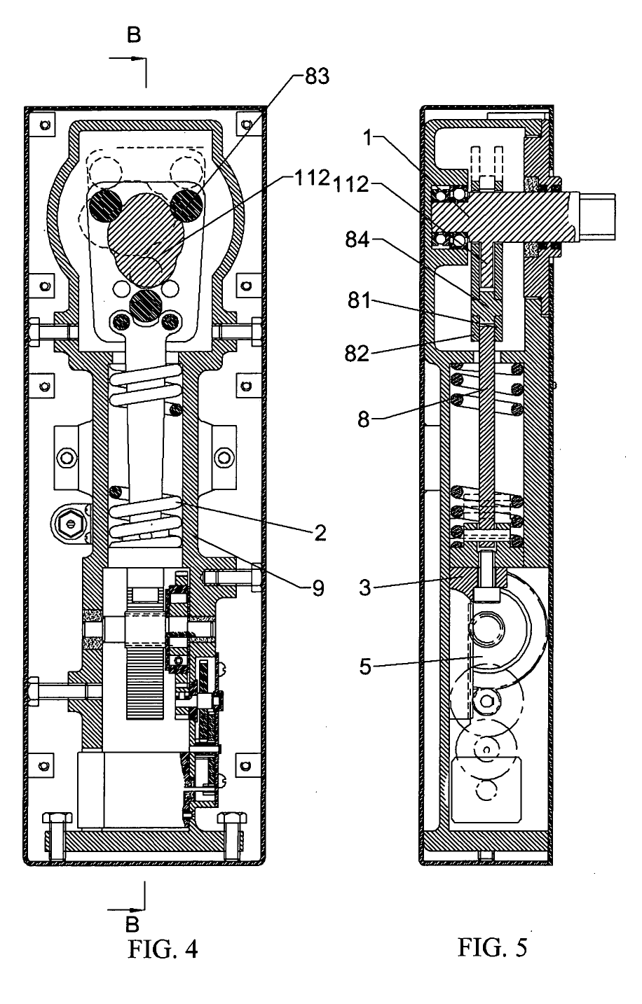

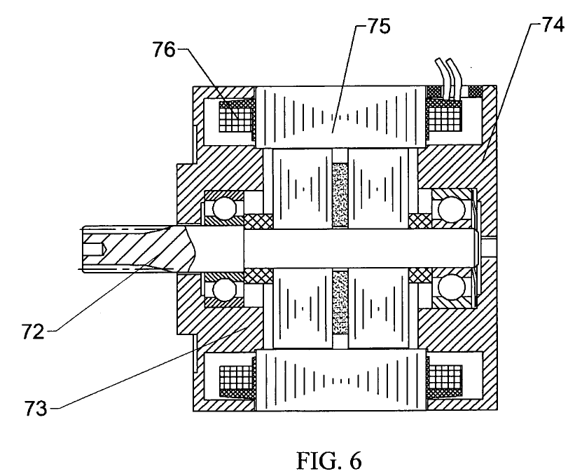

In the assembly of the floor hinge, an eccentric wheel 112 on the axle 1, eccentric wheel boards 81, 82 and its blocking pillar 83 define a horizontal shifting movement, and the board 81, 82 and its blocking pillar 83 are linked to the poking rod 8 of the rack, and the poking rod 8 of the rack is linked to the rack 3. The rack 3 and the one-way wheel 5 in the one-way transmission mechanism are engaged. Such mechanism fits the application with a large pushing force and rotation. Further, the eccentric wheel 112 could be a two-way eccentric wheel, and the two blocking pillars 83 installed in the corresponding boards 81, 82 are disposed on both sides of the eccentric wheel to constitute a two-way push, and a board balance positioning pillar 84 is installed at the position where the corresponding boards 81, 82 and the poking rod 8 of the rack are coupled. Such arrangement fits the application for pushing a door from both sides better, and its structure is more reasonable. In FIGS. 4 to 5, if a door is opened, the door panel is pulled or pushed manually, and the axle 1 is rotated synchronously to drive the two-way eccentric wheel 112 on the axle 1 in the floor hinge to rotate clockwise (or counterclockwise). With the action of a blocking pillar 83, the boards 81, 82 are shifted towards a direction, and the poking rod 8 of the rack drives the rack 3 to shift horizontally. The energy storing spring 2 is comprised to store its resilient energy. In the same time, since the rack 3 drives the engaged one-way wheel 5 to rotate, the magnetic damper mechanism 7 is not working and providing no damping force under the one-way action of the one-way transmission mechanism. The door is rotated according to the manual pulling or pushing speed.

If the door panel is released, the energy storing spring 2 releases its energy, so that the rack 3 drives the axle gear 11 to rotate in an opposite direction to drive the poking rod 8 of the rack and the eccentric wheel boards 81, 82 to shift horizontally in an opposite direction. As a result, the eccentric wheel 112 on the axle 1 rotates in the reverse direction, and the speed of the reverse rotation is determined by the magnetic damper mechanism, and its process and principle are identical to those as described in the door-shutter of the preferred embodiment of the present invention.

What is claimed is:

1. An auto-door device, comprising an axle pivotally coupled to a door panel and an axle resilient hinge; characterized in that said axle is linked to a one-way transmission mechanism while an output end of said one-way mechanism is linked to a magnetic damper mechanism.

2. The auto-door device of claim 1, wherein said output end of said transmission end of said one-way transmission mechanism is linked to a rotor of a magnetic line cutting type magnetic damper mechanism through said drive change mechanism.

3. The auto-door device of claim 2, wherein said magnetic damper mechanism includes a variable resistor serially connected to a circuit of a coil which is passed through by a plurality of magnetic lines of force.

4. The auto-door device of claim 2, wherein said one-way transmission mechanism comprises a one-way wheel linked with said axle and a gear shaft sleeve disposed at the external periphery of said one-way wheel to cope with said one-way transmission, and said gear shaft sleeve is engaged with an input end of said change drive mechanism.

5. The auto-door device of claim 3, wherein said one-way transmission mechanism comprises a one-way wheel linked with said axle and a gear shaft sleeve disposed at the external periphery of said one-way wheel to cope with said one-way transmission, and said gear shaft sleeve is engaged with an input end of said change drive mechanism.

6. The auto-door device of claim 4, wherein said one-way wheel comprises an aslant groove disposed at an external periphery of said one-way wheel for accommodating a rolling cylinder and a lateral pushing spring, and said rolling cylinder has a diameter larger than the sum of a depth at an end of said aslant groove and a gap between said one-way wheel and said gear shaft sleeve and smaller than the sum of a depth at another end of said aslant groove and a gap between said one-way wheel and said gear shaft sleeve.

7. The auto-door device of claim 5, wherein said one-way wheel comprises an aslant groove disposed in equidistant intervals of an external periphery of said one-way wheel for accommodating said rolling cylinder and said lateral pushing spring, and said aslant groove is curved.

8. The auto-door device of claim 4, wherein said axle is linked to a rack, and said rack, said one-way transmission mechanism, said gear change drive mechanism and said damper mechanism are disposed in a housing of said auto-door device, and said axle resilient hinge is an energy storing hinge disposed on a sliding track of said rack, and a regulating end of said variable resistor is installed in said housing of said auto-door device at a position corresponding to an exposed hole.

9. The auto-door device of claim 5, wherein said axle is linked to a rack, and said rack, said one-way transmission mechanism, said gear change drive mechanism and said damper mechanism are disposed in a housing of said auto-door device, and said axle resilient hinge is an energy storing hinge disposed on a sliding track of said rack, and a regulating end of said variable resistor is installed in said housing of said auto-door device at a position corresponding to an exposed hole.

10. The auto-door device of claim 6, wherein said axle is linked to a rack, and said rack, said one-way transmission mechanism, said gear change drive mechanism and said damper mechanism are disposed in a housing of said auto-door device, and said axle resilient hinge is an energy storing hinge disposed on a sliding track of said rack, and a regulating end of said variable resistor is installed in said housing of said auto-door device at a position corresponding to an exposed hole.

11. The auto-door device of claim 7, wherein said axle gear disposed on said axle in said housing of said auto-door device is engaged with said rack; said energy storing hinge is disposed on a side in said housing of said auto-door device; and said one-way transmission mechanism linked to said axle, said gear change drive mechanism and said magnetic damper mechanism are disposed on another side of said housing of said auto-door device.

12. The auto-door device of claim 7 further comprising an eccentric wheel disposed on said axle in said housing of said auto-door device, an eccentric wheel board, and a blocking pillar to define a horizontal shifting movement, and said eccentric wheel board and said blocking pillar are linked to a poking rod of said rack, and said poking rod is linked to said rack, and said rack is engaged with said one-way wheel in said one-way transmission mechanism.

13. The auto-door device of claim 9, wherein said eccentric wheel is two-way eccentric wheel and said eccentric wheel board comprises two blocking cylinders disposed on both sides of said eccentric wheel to define a two-way horizontal shifting movement, and a board balance positioning pillar is disposed at the position where said eccentric board and said link rod of said rack are coupled.
